(19) United States
(12) Patent Application Publication
(10) Pub. No.: US 2012/0155711 A1
(43) Pub. Date: Jun. 21, 2012

(54) APPARATUS AND METHOD FOR ANALYZING VIDEO

(75) Inventors: Sahngwon RYOO, Daejeon (KR); Jae Yeong LEE, Daejeon (KR); Sung Lok CHOI, Gyeonggi-do (KR); Won Pil YU, Ulsan (KR)

(73) Assignee: Electronics and Telecommunications Research Institute, Daejeon (KR)

(21) Appl. No.: 13/328,318

(22) Filed: Dec. 16, 2011

(30) Foreign Application Priority Data
Dec. 16, 2010 (KR) 10-2010-0129531

(51) Int. Cl. G06K 9/00

(52) U.S. Cl. 382/104

(57) ABSTRACT

Disclosed are an apparatus and a method for analyzing a video. The video analyzing apparatus includes a route analyzing unit configured to analyze a subject of a first-person view video and an object represented in the first-person view video based on the first-person view video and generate route information of the subject and the object; and an event analyzing unit configured to classify the first-person view video as a semantic event using the route information.

### CROSS-REFERENCE TO RELATED APPLICATIONS

This application claims priority to and the benefit of Korean Patent Application No. 10-2010-0129531 filed in the Korean Intellectual Property Office on Dec. 16, 2010, the entire contents of which are incorporated herein by reference.

### TECHNICAL FIELD

The present invention relates to an apparatus and a method for analyzing a video.

### BACKGROUND

Since the rapid development of the automobile industry, the number of vehicles manufactured has increased. Therefore, accidents relating to the vehicles such as a car accident are also correspondingly increased.

Therefore, in response to accidents relating to the vehicle, the installation of a vehicle black box for recording incidents or accidents relating to the vehicle is being increased. In aircrafts, a black box is served to store information such as an operation status of an airplane, a physical condition of a driver, and voice data between the drivers at the moment of the accident in an internal memory. Subsequently, after an accident of an aircraft, once the black box is collected and analyzed, it is possible to backtrack leading up to the moment of the accident.

As the same principle, a car black box is a device for obtaining information required to determine how the accident is caused when a car accident occurs. Examples of information that is stored in the black box include a speed of a car immediately before the collision between cars, acceleration, a steering angle, an operational status of a hazard light, and a driving status of various lamps.

The car black box is used to prevent a dispute that may occur when a correct cause of the car accident cannot be investigated, when a driving car collides with or hits another car or a person. This car black box captures and records images from a camera attached to the car, which simply records information regarding the driving status of the car.

### SUMMARY

The present invention has been made in an effort to provide an apparatus and a method for analyzing a video that summarizes and records captured images according to main events.

An exemplary embodiment of the present invention provides an apparatus for analyzing a video, including: a route analyzing unit configured to analyze a subject of a first-person view video and an object represented in the first-person view video based on the first-person view video and generate route information of the subject and the object; and an event analyzing unit configured to classify the first-person view video as a semantic event using the route information.

Another exemplary embodiment of the present invention provides a method for analyzing a video, including: a route analyzing step to analyze a subject of a first-person view video and an object represented in the first-person view video based on the first-person view video and generate route information of the subject and the object; and an event analyzing step to classify the first-person view video as a semantic event using the route information.

According to exemplary embodiments of the present invention, the captured images are summarized and recorded according to a main accident or event, which allows the images concerning the accident or event to be easily searched and analyzed.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram showing an exemplary embodiment of the present invention.

FIG. 2 is a schematic diagram of a video analyzing apparatus according to an exemplary embodiment of the present invention.

FIG. 3 is a diagram showing an object detecting unit.

FIGS. 4A and 4B are diagrams showing two examples for explaining route tracking.

FIG. 5 is a schematic diagram showing a concept of an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

The following description illustrates the principles of the present invention. It will thus be appreciated that those skilled in the art will be able to devise various arrangements that, although not explicitly described or shown herein, embody the present principles and are included within its spirit and scope. All examples and conditional language recited herein are intended for pedagogical purposes to aid the reader in understanding the present principles and the concepts contributed by the inventor(s) to further the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudo code, and the like represent various processes which may be substantially represented in computer readable media and so executed by a computer or processor, whether or not such computer or processor is explicitly shown.

The functions of the various elements shown in the figures that include functional blocks shown as a processer or a similar concept thereof may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

The foregoing objects, features, and advantages will be more apparent with reference to the following description in connection with the accompanying drawings. Thus those skilled in the art can easily perform the technical idea of the present invention. Further, if it is determined that the detailed description of the related art may unnecessarily deviate from the gist of the present invention, the detailed description of the related art will be omitted. Hereinafter, exemplary embodiments of the present invention will be described in detail with reference to the accompanying drawings.

The exemplary embodiments of the present invention relate to a video analyzing apparatus and a method thereof which analyze a first-person view video to classify as a semantic event. Accordingly, the first-person view video can be summarized and the behavior pattern of a subject of the first-person view video can be analyzed. Annotation information according to the classified event is stored and classified together with the summarized video, which allows the video to be easily searched or analyzed. The annotation information may include information that is defined by a semantic analysis of the event classified based on a predetermined criteria.

The first-person view video refers to a video captured according to a view point of a subject who takes the video. The subject who takes the video may include a moving body such as a vehicle or a moving person. For example, in the case of the capturing device in the car black box, the first-person view video refers to a video of another vehicle or a pedestrian captured by the capturing device installed in the vehicle at the view point of the vehicle. Further, the subject who takes the video refers to the capturing device or a vehicle having the capturing device installed therein.

The objects of the first-person view video to be analyzed are a subject of the first-person view video and an object that are represented in the first-person view video, and specifically, the route or track of the object and the subject. In the above vehicle example, the subject is a vehicle having the capturing device installed therein and the object is the other vehicle or pedestrian displayed in the captured video. Hereinafter, the terminologies of the subject and the object with the above-described meanings with respect to the first-person view video will be used.

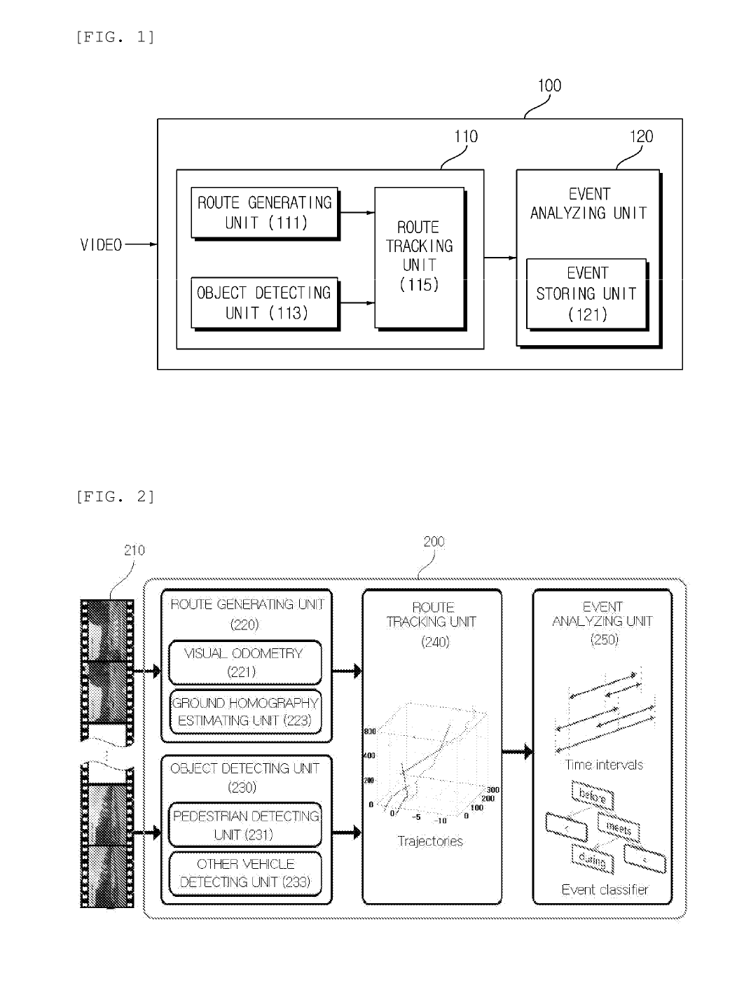

FIG. 1 is a diagram showing an exemplary embodiment of the present invention.

Referring to FIG. 1, a video analyzing apparatus 100 includes a route analyzing unit 110 that analyzes a subject of a first-person view video and an object represented in the first-person view video based on the first-person view video and generates route information of the subject and the object, and an event analyzing unit 120 that classifies the first-person view video as a semantic event using the route information.

Here, the subject and the object include moving bodies, but are not limited thereto. For example, the subject may be a moving vehicle and the object may be also a moving vehicle or a pedestrian. Further, the subject may be a moving vehicle, but the object may be a fixed object such as a still vehicle or roadside trees. In principle, the subject and the object are analyzed based on the first-person view video, but additional information created by a GPS or a sensor such as an acceleration sensor may be also used.

The route information of the subject and the object is generated by analyzing the first-person view video. The route information may include position information, timing information, speed information, and route information for each of the subject and the object and unique information of the subject and the object. The unique information refers to unusual status other than normal status. For example, in the case of a moving body, information of speed and distance for an unusual status such as sudden acceleration, sudden deceleration, and crash stop may be included. The route information may include information represented by a three-dimensional coordinate system comprised of a two-dimensional spatial coordinate system and a one-dimensional time coordinate system of the subject and the object.

The semantic event may include an event in which the interaction between the subject and the object is classified based on a predetermined criterion. In the meantime, the semantic event may include sub events in which the events of each of the subject and the object are classified based on a predetermined criterion. The semantic event may further include an event that combines the sub events in order to define the interaction between the subject and the object. By allowing the combination of the sub events, the semantic event can be additionally extended. This extension can be embodied by learning training examples such as a human activity recognition system.

The semantic event includes definition of the meanings of predetermined behaviors of the subject and the object. Specifically, the meanings of respective events of the subject and the object or the meanings of the interaction therebetween can be defined according to a predetermined criterion. Further, various kinds of events can be added by adding a predetermined criterion. For example, in the case of a vehicle, “overtaking” as predetermined route information regarding a vehicle A corresponding to the subject and a vehicle B corresponding to the object, “sudden stop by a pedestrian” as predetermined route information regarding a vehicle A corresponding to the subject and a pedestrian B corresponding to the object can be classified as events having meanings. In the above examples, the “sudden stop by a pedestrian” may correspond to the combination of a sudden stop of the vehicle A and the sudden appearance of the pedestrian B. In this case, the sudden stop of the vehicle A and the sudden appearance of the pedestrian B are sub events that are events of the subject and the object, and the “sudden stop by a pedestrian” is an event that is the combination of the sub events. As described above, if these are classified as a semantic event, it is easy to store, search, and analyze the events.

The event analyzing unit 120 may include an event storing unit 121 that stores a first-person view video and route information corresponding to a classified semantic event. Therefore, the video analyzing apparatus 100 can summarize and store the first-person view video that is analyzed and classified as a main event, and thus easily perform search using the stored video and related information, and analyze the behavior pattern of the subject and the object.

The route analyzing unit 110 may include a route generating unit 111 that generates a route of the subject, an object detecting unit 113 that detects the object, and a route tracking unit 115 that maps and tracks the routes of the subject and the object. In order to generate the route information from the first-person view video, the route generating unit 111 generates information regarding the position of the subject and a ground plane. The information regarding the position of the subject may be generated by using the relative position of a pattern that is represented in adjacent images of the first-person view video.

The object detecting unit 113 may detect the position of the object from an image of the first-person view video, and the route tracking unit 115 may map the route of the subject onto a coordinate system, and map the object on the basis of the coordinate system to which the subject is mapped. Further, the route tracking unit 115 may compare the information detected from the object detecting unit 113 with a predetermined hypothesis to check the validity of the detected information. The validity check may be performed using a position, a size, or a color histogram. If the information detected by the validation check does not match with the predetermined information, the predetermined hypothesis may be changed and updated by performing the validation check again.

Meanwhile, the spirit of the present invention disclosed in this specification can be embodied by a video analyzing method. The video analyzing method includes a route analyzing step that analyzes a subject of a first-person view video and an object represented in the first-person view video based on the first-person view video and generates route information of the subject and the object, and an event analyzing step that classifies the first-person view video as a semantic event using the route information. Here, the semantic event may include an event in which the interaction between the subject and the object is classified based on a predetermined criterion.

The event analyzing step may include an event storing step that stores a first-person view video and route information corresponding to a classified semantic event.

The route analyzing step may include a route generating step that generates a route of the subject, an object detecting step that detects an object, and a route tracking step that maps and tracks the routes of the subject and the object. The route generating step may generate information regarding the position of the subject and a ground plane. The information regarding the position of the subject may be generated by using the relative position of a pattern that is represented in an adjacent image of the first-person view video.

The object detecting step may detect the position of the object from an image of the first-person view video.

The route tracking step may map the route of the subject onto a coordinate system, and map the object on the basis of a coordinate system. The route tracking step may compare the information detected in the object detecting step with a predetermined hypothesis to check the validity of the detected information.

The route information may include information represented by a three-dimensional coordinate system comprised of a two-dimensional spatial coordinate system and a one-dimensional time coordinate system of the subject and the object.

Since the detailed description of the video analyzing method is similar to the video analyzing apparatus shown in FIG. 1, the description will be omitted.

Hereinafter, exemplary embodiments regarding the spirit of the present invention will be described.

### EXEMPLARY EMBODIMENTS

Hereinafter, an exemplary embodiment of an apparatus or a method for generating a personal driving diary using the video analyzing apparatus or the video analyzing method will be described. In the following description, a video captured at a view point of the vehicle by a capturing device installed in a vehicle is an example of a first-person view video. Here, the vehicle corresponds to a subject, and another vehicle or a pedestrian captured by the capturing device corresponds to an object.

However, the spirit of the present invention is not limited thereto, and can be applied to any field that can analyze and classify main accidents or events between a subject of the video generated at the first-person view and the object represented in the video. The representative examples may include a personal terminal including a capturing device such as a cellular phone, a PMP, or a smart phone.

FIG. 2 is a schematic diagram of a video analyzing apparatus according to an exemplary embodiment of the present invention.

Referring to FIG. 2, the video analyzing apparatus for generating a vehicle driving diary 200 includes a route generating unit 220, an object detecting unit 230, a route tracking unit 240, and an event analyzing unit 250. The video analyzing apparatus for generating a vehicle driving diary 200 analyzes a video 210 (a first-person view video in which a vehicle is a subject) captured by a capturing device such as a camera attached to the vehicle to configure and represent semantically an important driving event of a driver. This semantic event configures an event log so that the driving diary is summarized and classified, the behavior of the vehicle is recognized and the driving habit of the driver is analyzed.

The route generating unit 220 may use a visual odometry algorithm to measure a self-motion of the camera. Specifically, the trajectory of the driving vehicle is obtained with respect to the first global position, which allows the position of the driving vehicle to be recorded on a map. The route generating unit 220 finds the position of the driving vehicle and measures a planar homography of the ground plane. The route generating unit 220 can calculate an object thing that is mapped from an image coordinate system as a metric coordinate system with respect to the subject (driving vehicle).

The route generating unit 220 may include a visual odometry 221 and a ground homography estimating unit 223.

The visual odometry 221 calculates the relative position between the adjacent images in the video 210 to accumulate the calculated results for global localization. The features that do not locally change are extracted from each frame. The geometric relation may be measured by using an adaptive RANSAC and a five-point algorithm.

In the meantime, the ground homography estimating unit 223 uses a regular pattern of a ground such as the surface of the earth to measure the ground plane. Therefore, it allows the global localization of another vehicle or a pedestrian (object).

The object detecting unit 230 detects another vehicle or the pedestrian from each image in the video 210. The object detecting unit 230 may include a pedestrian detecting unit 231 and an other vehicle detecting unit 233.

The route generating unit 220 may measure the position of the object detected on the global coordinate system on the basis of the geometric structure of an analyzed scene. The position of the object that is represented by an image coordinate system can be transformed to a global coordinate system on the basis of the information from the route generating unit 220. In order to detect a pedestrian, a sliding window can be applied using a HOG (histogram of gradients), and a vertical edge filtering can be performed for efficient detection. A plurality of contours of a rear side of the vehicle or image information can be used to detect another vehicle.

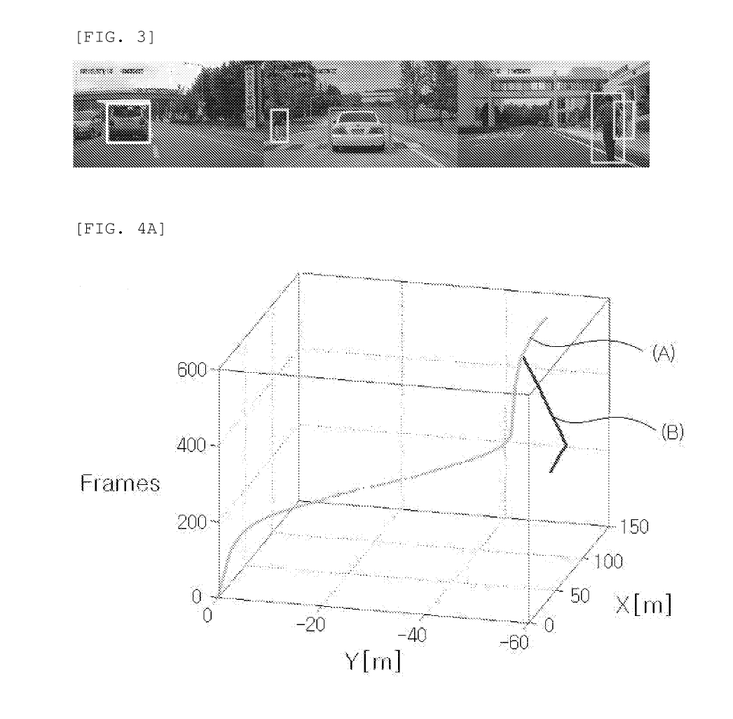

FIG. 3 is a diagram showing an object detecting unit. Referring to FIG. 3, the object to be detected is represented with a rectangular box.

The route tracking unit 240 may use an object tracking algorithm in order to obtain trajectories of a vehicle and a pedestrian.

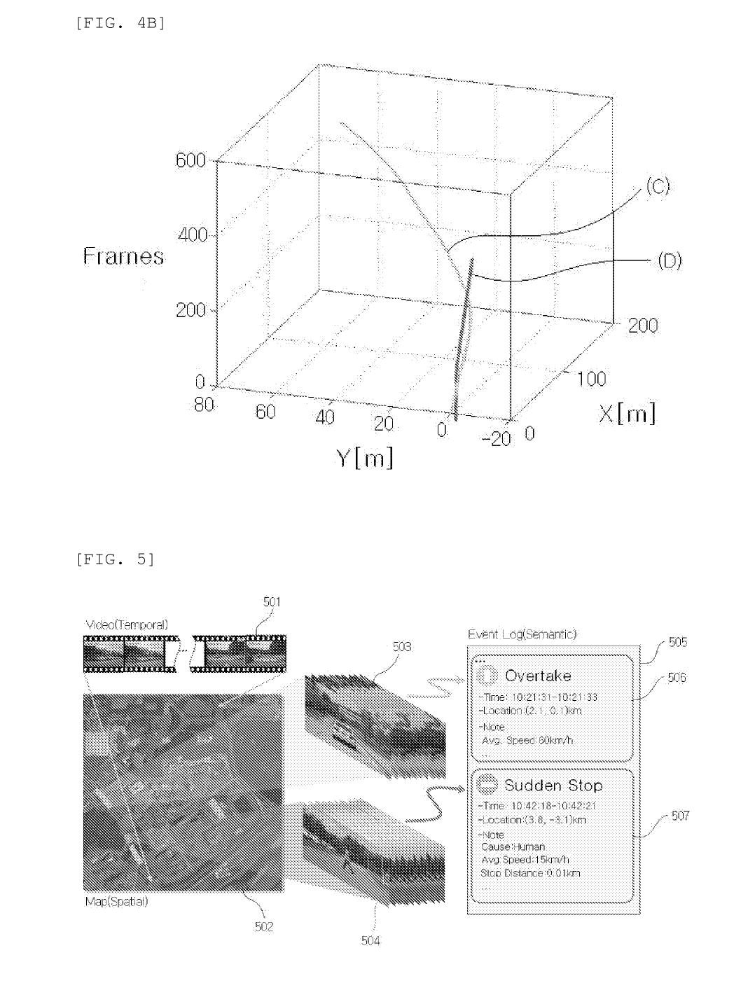

FIGS. 4A and 4B are diagrams showing two examples for explaining route tracking. Referring to FIG. 4A, the reference symbol (A) represents a route (trajectory) of a driving vehicle, and the reference symbol (B) represents a route (trajectory) of a pedestrian. Further, in FIG. 4B, the reference symbol (C) represents a route (trajectory) of a driving vehicle, and the reference symbol (D) represents a route (trajectory) of another vehicle. As shown in FIGS. 4A and 4B, the routes of both the subject and the object are tracked in a single coordinate system (a three-dimensional coordinate system configured by a two-dimensional spatial coordinate system and a one-dimensional time coordinate system).

In the meantime, the route tracking unit 240 may use an appearance model in order to generate an valid detection result of the object detecting unit 230 and precisely track the routes. By setting one hypothesis for every object and comparing the result from the object detecting unit 230 with the set hypothesis, the similarity can be calculated using a position, a size, and a color histogram. The validity check can be performed with respect to the calculated similarity. If the validity check is not satisfied and the result does not match the set hypothesis, a new hypothesis is set. Further, a color template can be generated from an elliptical mask and an image field (a bounding box of the object). If the validity check is not satisfied, a template tracker can be used to update the hypothesis that does not match the result. The color template is updated when the result from the object detecting unit 230 matches the new hypothesis. In the exemplary embodiment, an extended Kalman filter may be used.

The event analyzing unit 250 analyzes and classifies the video as a semantic event using the trajectory of the driving vehicle in the route generating unit 220 and the trajectory of the object in the route tracking unit 240. In other word, the event analyzing unit 250 analyzes and recognizes the semantic event that is hierarchically classified from the route information including a trajectory. In the meantime, the event analyzing unit 250 adds a new driving event to analyze the video 210 and stores analyzed event information including the position of the driving vehicle and contextual information that refers to circumstantial information of a corresponding event in the video 210.

The event analyzing unit 250 hierarchically classifies basic events, and allows recognizing a complicated event that includes a complicated situation in which the basis events are combined using the classified events.

The basic events may be defined by using a time interval between the starting time and the finishing time. The basic events can be classified into “passing”, “car in front”, “car at behind”, “side-by-side”, “accelerating”, “decelerating”, “vehicle stopped”, and “pedestrian in front”. The event analyzing unit 250 can recognize the basic events using information extracted from a three-dimensional trajectory of the driving vehicle, and another vehicle or the pedestrian. Here, the three-dimensional trajectory may be a coordinate system configured by a two-dimensional spatial coordinate system and a one-dimensional time coordinate system, and the extracted information may include information concerning orientation, a speed, acceleration, and a relative two-dimensional space between the subject and the object.

The analysis with regard to the complicated event can be embodied by an extended STR match (spatial-temporal relationship match) using human activity recognition. In the exemplary embodiment, a decision tree classifier of the STR match is used. The decision tree classifier is trained by training examples. That is, the decision tree classifier may be obtained using a correlation such as an important space-time pattern of the above-described basic events. The decision tree classifier allows analysis of a complicated event other than the basic events, and addition of a new event by learning various events through training examples by a new video, which enables precise analysis of the event with respect to the video.

FIG. 4A shows a sudden stop caused by a pedestrian and FIG. 4B shows that the driving vehicle overtakes another vehicle.

FIG. 5 is a schematic diagram showing a concept of an exemplary embodiment of the present invention.

Referring to FIG. 5, the video analyzing apparatus for generating a vehicle driving diary can search an important vehicle event such as an accident, and can also provide materials that are capable of statistically analyzing the habit or pattern of the driver.

A video 501 is captured and input according to a time, and the video 501 is represented on a map 502 or a coordinate system by a route analyzing unit, an object detecting unit, and a route tracking unit so that the route is tracked and then route information is generated. The route information generated as described above is analyzed and classified as a semantic event in the event analyzing unit, and the analyzed and classified semantic event is stored as an event log 505 together with a corresponding video and semantic information. The stored event log 505 may further include detailed information regarding the event.

In FIG. 5, the event 503 in which the driving vehicle overtakes another vehicle is stored as a semantic event log 506. The detailed information for the corresponding event includes information such as a time, a position, and an average speed.

In FIG. 5, an event 504 that the driving vehicle is suddenly stopped by a pedestrian is stored as a corresponding semantic event log 507. The detailed information for the corresponding event includes a time, a position, a cause of stopping, an average speed, and a stopping distance.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An apparatus of analyzing a video, comprising:
a route analyzing unit configured to analyze a subject of a first-person view video and an object represented in the first-person view video based on the first-person view video and generate route information of the subject and the object; and
an event analyzing unit configured to classify the first-person view video as a semantic event using the route information.

2. The apparatus of claim 1, wherein the semantic event includes sub events in which the events of each of the subject and the object are classified based on a predetermined criterion.

3. The apparatus of claim 2, wherein the semantic event further includes an event that combines the sub events in order to define the interaction between the subject and the object.

4. The apparatus of claim 1, wherein the event analyzing unit includes:
an event storing unit configured to store a first-person view video and route information corresponding to the classified semantic event.

5. The apparatus of claim 1, wherein the route analyzing unit includes:
a route generating unit configured to generate a route of the subject;
an object detecting unit configured to detect the object; and
a route tracking unit configured to map and track the routes of the subject and the object.

6. The apparatus of claim 5, wherein the route generating unit generates information regarding the position of the subject and a ground plane.

7. The apparatus of claim 6, wherein the information regarding the position of the subject is generated by using the relative position of a pattern that is represented in adjacent images of the first-person view video.

8. The apparatus of claim 5, wherein the object detecting unit detects the position of the object from an image of the first-person view video.

9. The apparatus of claim 5, wherein the route tracking unit maps the route of the subject onto a coordinate system, and maps the object on the basis of the coordinate system.

10. The apparatus of claim 5, wherein the route tracking unit compares the information detected from the object detecting unit with a predetermined hypothesis to check the validity of the detected information.

11. A method of analyzing a video, comprising:
a route analyzing step to analyze a subject of a first-person view video and an object represented in the first-person view video based on the first-person view video and generate route information of the subject and the object; and
an event analyzing step to classify the first-person view video as a semantic event using the route information.

12. The method of claim 11, wherein the semantic event includes sub events in which the events of each of the subject and the object are classified based on a predetermined criterion.

13. The method of claim 12, wherein the semantic event further includes an event that combines the sub events in order to define the interaction between the subject and the object.

14. The method of claim 11, wherein the event analyzing step includes:
an event storing step to store a first-person view video and route information corresponding to the classified semantic event.

15. The method of claim 11, wherein the route analyzing step includes:
a route generating step to generate a route of the subject;
an object detecting step to detect the object; and
a route tracking step to map and track the routes of the subject and the object.

16. The method of claim 15, wherein the route generating step generates information regarding the position of the subject and a ground plane.

17. The method of claim 16, wherein the information regarding the position of the subject is generated by using the relative position of a pattern that is represented in adjacent images of the first-person view video.

18. The method of claim 15, wherein the object detecting step detects the position of the object from an image of the first-person view video.

19. The method of claim 15, wherein the route tracking step maps the route of the subject onto a coordinate system, and maps the object on the basis of the coordinate system.

20. The method of claim 15, wherein the route tracking step compares the detected information with a predetermined hypothesis to check the validity of the detected information.
